(19) United States
(12) Patent Application Publication
(10) Pub. No.: US 2015/0161767 A1
(43) Pub. Date: Jun. 11, 2015

(54) IMAGE TRANSMITTING APPARATUS, IMAGE PRESENTATION SYSTEM AND CONTROL METHOD

(71) Applicant: CANON KABUSHIKI KAISHA, Tokyo (JP)

(72) Inventor: Kazuhiro Monden, Inagi-shi (JP)

(21) Appl. No.: 14/563,541

(22) Filed: Dec. 8, 2014

(30) Foreign Application Priority Data
Dec. 10, 2013 (JP) 2013-255369

(51) Int. Cl. G06T 3/40

(52) U.S. Cl. CPC G06T 3/4092

(57) ABSTRACT

An image transmitting apparatus detects an orientation of the apparatus, and renders a display image having a resolution determined according to the detected orientation. Also, the image transmitting apparatus captures the rendered display image at a predetermined timing, and transmits the captured image to an image presentation apparatus. At this time, if a communication connection with the image presentation apparatus is established, the image transmitting apparatus renders the display image with the resolution being fixed irrespective of the orientation of the image transmitting apparatus.

### BACKGROUND OF THE INVENTION

1. Field of the Invention

The present invention relates to an image transmitting apparatus, an image presentation system, and a control method, and particularly to a technique for transferring an image displayed on a display screen to an external display apparatus and presenting the image.

2. Description of the Related Art

Conventionally, a technique is available that acquires (captures) what is displayed on the display screen of an information processing apparatus such as a PC as an image, transmits the image to an image presentation apparatus such as a liquid crystal projector via a network, and presents the image to the user. With the wide spread of information communication terminals such as smart phones and tablet terminals in recent years, the opportunity to use such terminals as apparatuses that transmit images that need to be presented is increasing.

The information communication terminals are designed to be held by users during use. Accordingly, control is performed so as to change a display representation on the display screen of the apparatus by taking into consideration the orientation of the apparatus. To be specific, the display representation is changed such that the upper direction of the display screen corresponds to the vertical upper direction in the real world. Such a change in the display representation is also used to, for example, control the rotation of images on an image viewing application executed by an information communication terminal. Japanese Patent Laid-Open No. 2009-141484 discloses a technique that, when a list of images recorded in an image capturing apparatus is displayed on a PC, controls the display orientation of the images displayed on the PC so as to reflect the up-down direction of the images displayed on the display screen of the image capturing apparatus.

However, the following problem may arise if, when images displayed on the display screen of an information communication terminal are transmitted to an image presentation apparatus to present the images, display control is performed so as to reflect the up-down direction of the images displayed on the display screen, as described in Japanese Patent Laid-Open No. 2009-141484.

Display control for information communication terminals in recent years changes the images rendered on the entire screen according to the orientation of the terminals, rather than changing each image on the image viewing application as disclosed in Japanese Patent Laid-Open No. 2009-141484. That is, when images displayed on the display screen are captured and transmitted, the images rendered on the display screen are changed each time there is a change in the orientation of the terminal, and thus the images presented by the image presentation apparatus may be frequently switched. To be specific, there is a possibility that the observer who is viewing the presented images may feel discomfort because images rendered by positioning objects and characters that need to be rendered in a portrait render range and images rendered by positioning objects and characters that need to be rendered in a landscape render range are alternately displayed.

### SUMMARY OF THE INVENTION

The present invention was made in view of such problems in the conventional technique. The present invention provides an image transmitting apparatus that appropriately presents, to the outside, an image displayed on an information communication terminal that performs display control according to the orientation of the terminal, an image presentation system, and a control method.

The present invention in its first aspect provides an image transmitting apparatus that renders a display image that is displayed on a display unit according to an orientation of the image transmitting apparatus, the apparatus comprising: a detecting unit configured to detect the orientation of the image transmitting apparatus; a rendering unit configured to render the display image having a resolution determined according to the orientation of the image transmitting apparatus detected by the detecting unit; and a communication unit configured to establish a communication connection with an image presentation apparatus, and capture and transmit the display image rendered by the rendering unit at a predetermined timing, wherein the rendering unit is configured to, if the communication connection with the image presentation apparatus performed by the communication unit is established, fix the resolution and render the display image irrespective of the orientation of the image transmitting apparatus.

The present invention in its second aspect provides an image presentation system in which an image presentation apparatus presents an image transmitted from an image transmitting apparatus, the image transmitting apparatus comprising: a detecting unit configured to detect an orientation of the image transmitting apparatus; a rendering unit configured to render a display image that is displayed on a display unit and has a resolution determined according to the orientation of the image transmitting apparatus detected by the detecting unit; and a communication unit configured to establish a communication connection with an image presentation apparatus, and capture and transmit the display image rendered by the rendering unit at a predetermined timing, the image presentation apparatus comprising: a receiving unit configured to receive the display image transmitted by the communication unit; and a presentation unit configured to present the display image received by the receiving unit, wherein the rendering unit is configured to, if a communication connection with the image presentation apparatus is established by the communication unit, fix the resolution and render the display image irrespective of the orientation of the image transmitting apparatus.

The present invention in its third aspect provides a method for controlling an image transmitting apparatus that renders a display image displayed on a display unit according to an orientation of the image transmitting apparatus, the method comprising: detecting the orientation of the image transmitting apparatus; rendering the display image having a resolution determined according to the detected orientation of the image transmitting apparatus; and establishing a communication connection with an image presentation apparatus, and capturing and transmitting the rendered display image at a predetermined timing, wherein if the communication connection with the image presentation apparatus is established, the display image is rendered with the resolution being fixed irrespective of the orientation of the image transmitting apparatus.

Further features of the present invention will become apparent from the following description of exemplary embodiments (with reference to the attached drawings).

### BRIEF DESCRIPTION OF THE DRAWINGS

FIG. 1 is a diagram showing a system configuration of an image presentation system according to an embodiment of the present invention.

FIG. 2 is a block diagram showing functional configurations of a tablet terminal 100 and a liquid crystal projector 200 according to an embodiment of the present invention.

FIGS. 3A, 3B, 3C and 3D are diagrams showing four different display representations of the tablet terminal 100 according to an embodiment of the present invention.

FIGS. 4A and 4B are flowcharts illustrating normal display control processing executed by the tablet terminal 100 according to an embodiment of the present invention.

FIG. 5 is a diagram illustrating various types of images generated through normal display control processing executed by the tablet terminal 100 according to an embodiment of the present invention.

FIGS. 6A and 6B are flowcharts illustrating screen transmission processing executed by the tablet terminal 100 according to an embodiment of the present invention.

FIG. 7 is a diagram illustrating various types of images generated through the screen transmission processing executed by the tablet terminal 100 according to an embodiment of the present invention.

FIG. 8 is another diagram illustrating various types of images generated through the screen transmission processing executed by the tablet terminal 100 according to an embodiment of the present invention.

FIGS. 9A, 9B, 9C and 9D are diagrams showing representations of images presented by a liquid crystal projector 200 and images displayed on a display unit 107 in normal screen transmission processing executed by the tablet terminal 100 according to an embodiment of the present invention.

FIGS. 10A, 10B, 10C and 10D are diagrams showing representations of images presented by the liquid crystal projector 200 and images displayed on the display unit 107 in screen transmission processing executed by the tablet terminal 100 according to an embodiment of the present invention.

FIGS. 11A, 11B, 11C and 11D are other diagrams showing representations of images presented by the liquid crystal projector 200 and images displayed on the display unit 107 in screen transmission processing executed by the tablet terminal 100 according to an embodiment of the present invention.

FIGS. 12A, 12B, 12C and 12D are diagrams showing other representations of images presented by the liquid crystal projector 200 and images displayed on the display unit 107 in an image presentation system according to a variation of an embodiment of the present invention.

### DESCRIPTION OF THE EMBODIMENTS

Hereinafter, an exemplary embodiment of the present invention will be described in detail with reference to the drawings. An embodiment given below will be described taking an example in which the present invention is applied to a tablet terminal serving as an example of an image transmitting apparatus and a liquid crystal projector serving as an example of an image presentation apparatus included in an image presentation system in which the image presentation apparatus presents an image transmitted from the image transmitting apparatus. However, the present invention is applicable to any device as long as the image presentation apparatus is configured to present an image transmitted from an image transmitting apparatus. That is, the image presentation apparatus is not limited to an apparatus that presents transmitted images through projection such as a liquid crystal projector, and is applicable to any device that presents images such as various types of displays. The image transmitting apparatus is also applicable to a mobile phone such as a so-called smart phone, an image capturing apparatus such as a digital camera, a music player provided with a display unit, or a notebook computer.

Configuration of Image Presentation System

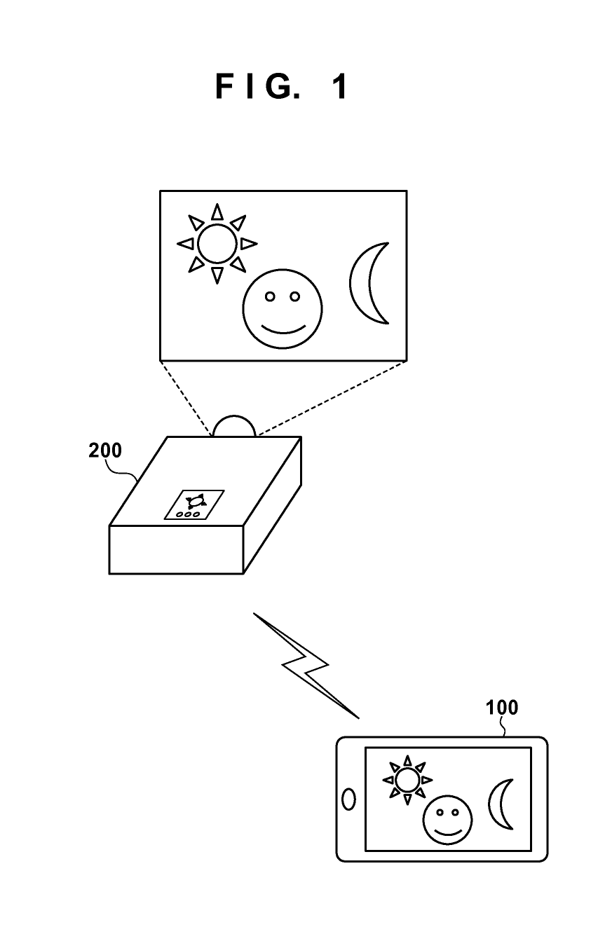

FIG. 1 is a diagram showing a configuration of an image presentation system according to an embodiment of the present invention.

As shown in the diagram, in the present embodiment, image data generated by a tablet terminal 100 is transmitted to a liquid crystal projector 200 via wireless communication. Then, the liquid crystal projector 200 projects the image data onto a projection surface (not shown) so as to present the image to the user. The communication scheme between the tablet terminal 100 and the liquid crystal projector 200 is not limited to wireless communication, and may be wired communication using an Ethernet® cable defined by IEEE 802.3.

Functional Configurations of Tablet Terminal 100 and Liquid Crystal Projector 200

FIG. 2 is a block diagram showing functional configurations of the tablet terminal 100 and the liquid crystal projector 200 according to the embodiment of the present invention.

A CPU 101 controls operations of blocks included in the tablet terminal 100. To be specific, the CPU 101 controls the operations of the blocks by reading an operation program for operating the blocks or an application program stored in a flash memory 104 or an HDD 105, loading the read program into a RAM 102, and executing the program.

The flash memory 104 is, for example, a rewritable non-volatile memory. The flash memory 104 stores therein, in addition to the operation program for operating the blocks of the tablet terminal 100, parameters and the like required by the operations of the blocks. The HDD 105 is a storage device removably connected to the HDD 105. The HDD 105 stores therein, in addition to the operation program for operating the blocks or application program, an operating system (OS) or the like that performs control on the entire operations of the tablet terminal 100. The RAM 102 is a volatile memory. The RAM 102 not only serves as a loading area for each program, but also stores therein intermediate data output by the operations of the blocks, and the like. In the present embodiment, the RAM 102 is also used as a storage area for temporarily storing image data that is transmitted to the liquid crystal projector 200.

A display unit 107 is a display apparatus that is internally or externally provided to the tablet terminal 100, such as an LCD or an organic EL panel. The display control of images displayed on a display region of the display unit 107 is performed by a display control unit 108. The generation of display images displayed on the display region of the display unit 107 is performed by a GPU 111. To be specific, the GPU 111 reads GUI data or the like stored in, for example, the HDD 105, loads the read GUI data into an internal GPU memory, and thereafter allocates a two-dimensional render region for rendering display images in a VRAM 103 in accordance with information regarding screen forming. Then, the GPU 111 renders a display image by using the GUI data or the like, and stores the rendered display image in the render region. The display control unit 108 reads the display image stored in the VRAM 103 in the manner described above, and performs processing for displaying the image on the display unit 107. If the RAM 102 has a sufficiently high access speed, the VRAM 103 may be replaced by the RAM 102.

An operation unit 109 may include operation buttons, or may be a user interface of the tablet terminal 100 such as a touch sensor provided together with the display unit 107. If the operation unit 109 detects an input of operation by the user, it transmits the corresponding control signal to the CPU 101.

A tablet communication unit 110 is a communication interface of the tablet terminal 100. The communication unit 110 includes an antenna, an RF unit, and a base band unit. In the present embodiment, the tablet terminal 100 establishes a communication connection with the liquid crystal projector 200 through wireless communication via the communication unit 110 and a communication network 150, and is capable of data communication using packets that conform to the corresponding wireless communication specifications. The communication unit 110 encodes image data that is transmitted to the liquid crystal projector 200 by an encoding unit (not shown) and transmits the encoded data.

An orientation detection unit 106 is, for example, an accelerometer or a gyro sensor. The orientation detection unit 106 detects the orientation of the tablet terminal 100, and outputs orientation information. In the present embodiment, the orientation information is information indicating that the tablet terminal 100 is vertically held (i.e., the longitudinal direction of the display region corresponds to the vertical direction of the real world) or horizontally held (i.e., the transverse direction of the display region corresponds to the vertical direction in the real world).

A CPU 201 controls the operations of the blocks included in the liquid crystal projector 200. To be specific, the CPU 201 reads an operation program for operating the blocks stored in a flash memory 203, loads the read program into a RAM 202, and executes the program so as to control the operations of the blocks.

The flash memory 203 is, for example, a rewritable non-volatile memory. The flash memory 203 stores therein, in addition to the operation program for operating the blocks of the liquid crystal projector 200, parameters and the like required by the operations of the blocks. The RAM 202 is a volatile memory. The RAM 202 not only serves as a loading area for each program, but also stores therein intermediate data output by the operations of the blocks, and the like.

A communication unit 209 is a communication interface of the liquid crystal projector 200. In the present embodiment, the liquid crystal projector 200 is capable of establishing a communication connection with the liquid crystal projector 200 via the communication unit 209 and the communication network 150. The communication unit 209 receives image data transmitted from the tablet terminal 100 when the liquid crystal projector 200 is set in a mode in which the liquid crystal projector 200 projects an input signal from the apparatus with which a communication connection is established. The liquid crystal projector 200 of the present embodiment is also configured to transmit, to the tablet terminal 100 via the communication unit 209, information indicating that the mode in which the liquid crystal projector 200 projects an input signal from the apparatus with which a communication connection is established has been set.

A decoder 205 performs decoding processing on the image data received by the communication unit 209. The image data decoded by the decoder 205 is loaded into a VRAM 204. Also, an image processing unit 210 applies projection image processing on the image data loaded into the VRAM 204. The projection image data generated in this way is projected onto a projection surface by a projection control unit 207 using a projection unit 206. The projection unit 206 includes a liquid crystal panel, a lens, and a light source.

An operation unit 208 is a user interface of the liquid crystal projector 200 such as a signal receiving unit that receives an infrared signal transmitted from a remote controller provided with, for example, a power button and menu buttons or input buttons for operation of the liquid crystal projector 200. If the operation unit 208 detects an input of operation by the user, it outputs the corresponding control signal to the CPU 201.

Normal Rendering and Display

A behavior of the tablet terminal 100 of the present embodiment when changing the display method according to the orientation of the apparatus will now be described with reference to the drawings.

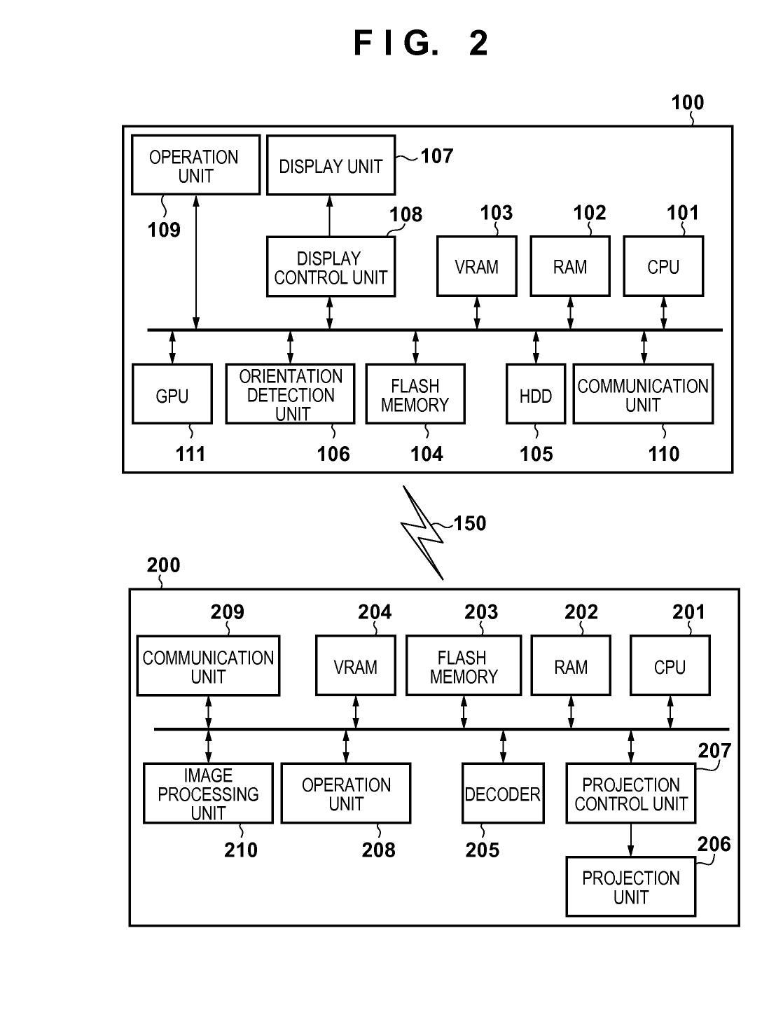

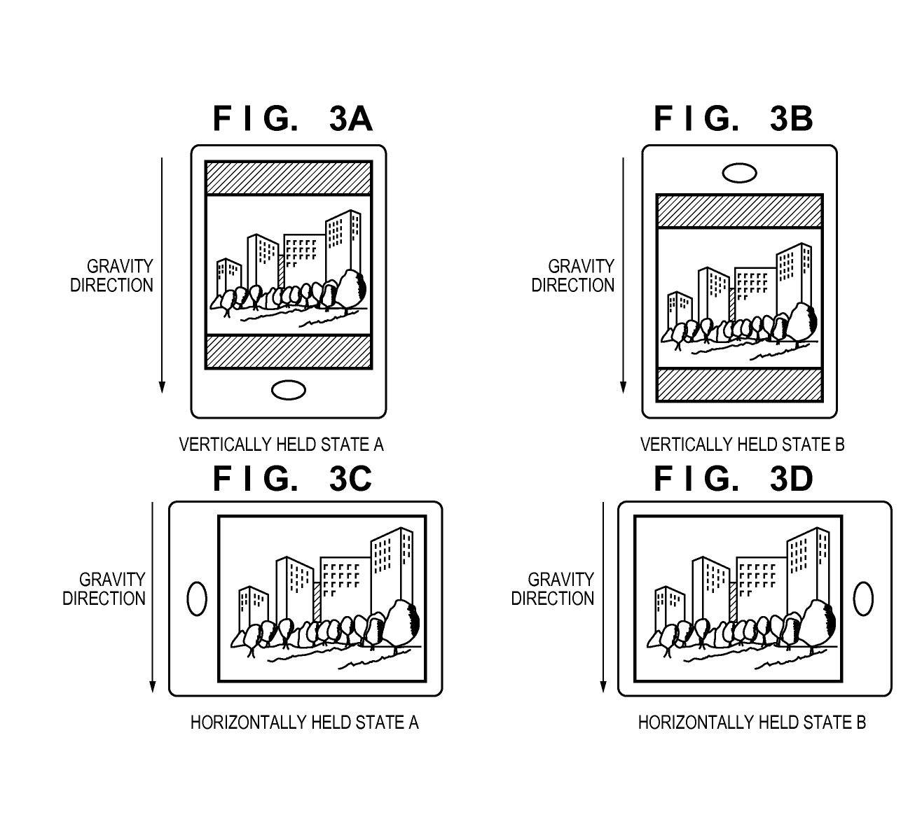

Display representations on the display unit 107 of the tablet terminal 100 of the present embodiment are classified into four different types. FIGS. 3A to 3D show four different display representations together with the outer configuration of the tablet terminal 100. FIG. 3A shows a state in which the tablet terminal 100 is vertically held, which is hereinafter referred to as a “vertically held state A”. This state is set as a reference state. FIG. 3B shows a state in which the tablet terminal 100 is vertically held by being turned upside down from the reference state. Hereinafter, this state will be referred to as a “vertically held state B”. FIG. 3C shows a state in which the tablet terminal 100 is horizontally held by being rotated in a clockwise direction by 90 degrees from the reference state. Hereinafter, this state will be referred to as a “horizontally held state A”. FIG. 3D shows a state in which the tablet terminal 100 is horizontally held by being rotated in a counterclockwise direction by 90 degrees from the reference state. Hereinafter, this state will be referred to as a “horizontally held state B”. The examples shown in FIGS. 3A to 3D respectively illustrate image display states. As shown in the diagrams, display control is performed such that the vertical upper direction in the real space corresponds to the upper direction of the image, and the gravity direction in the real space corresponds to the lower direction of the image, no matter what the orientation of the tablet terminal 100 is.

Display Control Processing

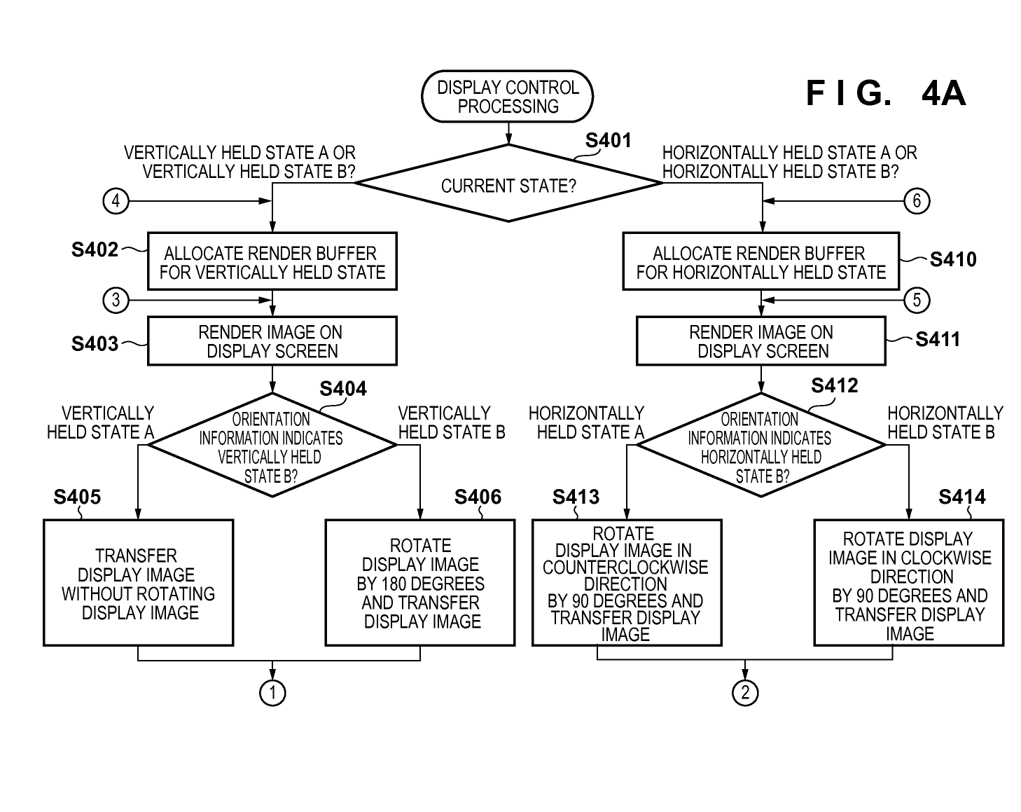

Next is a description of display control processing that, in the tablet terminal 100 in a normal state, renders a display image that is displayed on the display unit 107 according to the orientation information output from the orientation detection unit 106 and displays the display image, with reference to the flowcharts shown in FIGS. 4A and 4B. The present embodiment will be described taking, as an example, display control processing with respect to an application for displaying text data constituted by twelve characters so that changes in the rendered display images can be clearly seen. The display control processing is implemented by the CPU 101 reading a program corresponding to the text display application from the HDD 105, loading the program into the RAM 102, and executing the program.

In S401, the CPU 101 refers to the orientation information output from the orientation detection unit 106, and determines whether the orientation of the tablet terminal 100 is in a vertically held state or a horizontally held state. If it is determined that the orientation information indicates “vertically held state A” or “vertically held state B”, the CPU 101 advances the processing to S402. If it is determined that the orientation information indicates “horizontally held state A” or “horizontally held state B”, the CPU 101 advances the processing to S410.

In S402, the GPU 111 allocates a render region (buffer) for rendering the display image with respect to the text display application onto the VRAM 103. The buffer is a two-dimensional region in which the resolution is determined according to the current orientation of the tablet terminal 100. In this step, the tablet terminal 100 is in a vertically held state.

Accordingly, in the case where the resolution of the display unit 107 is 768 [px]×1024 [px] in the reference state (vertically held state A), a buffer having a width of 768 [px] and a height of 1024 [px] is allocated onto the VRAM 103.

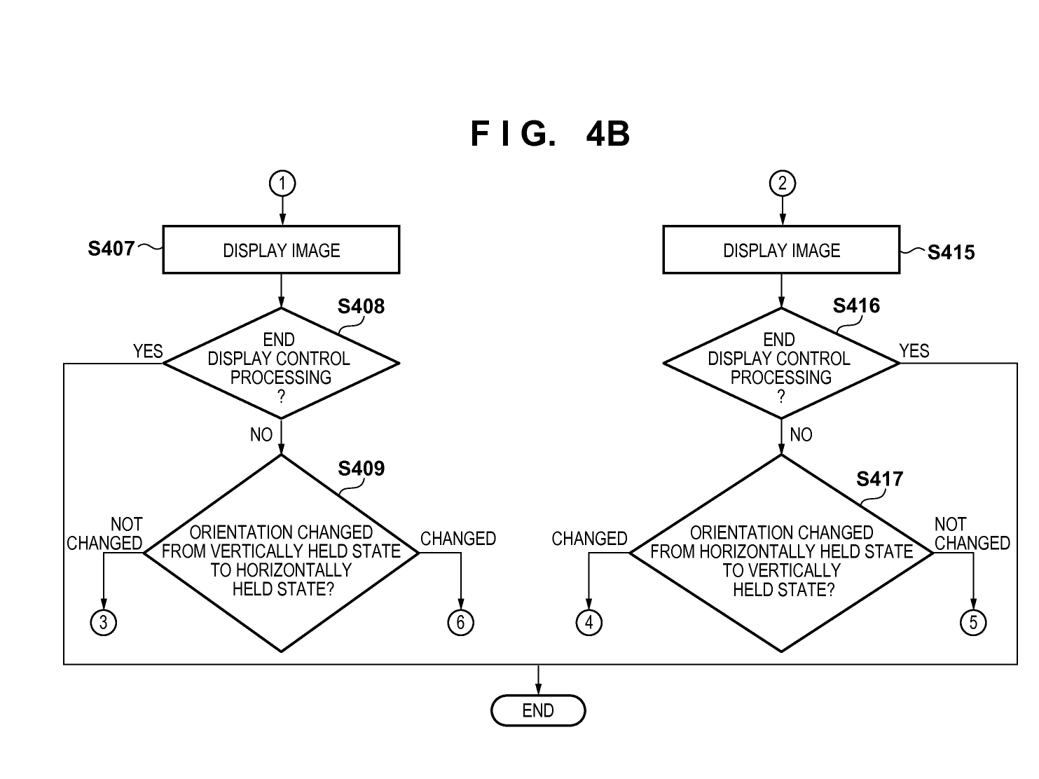

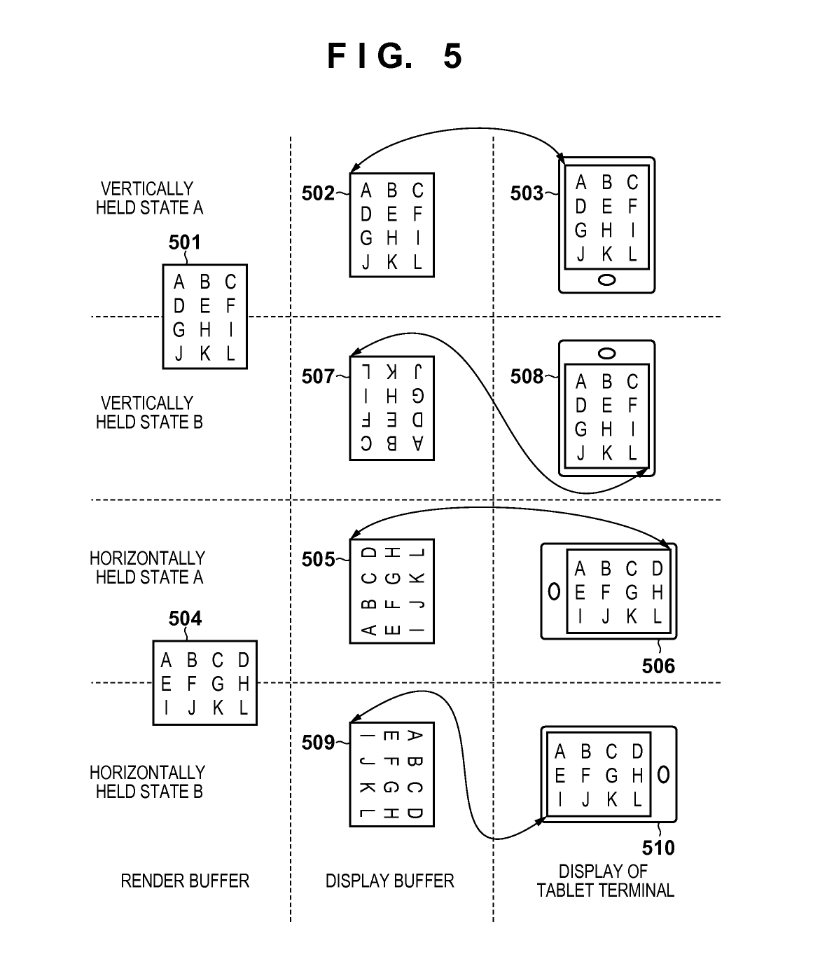

In S403, the GPU 111 renders a text image corresponding to the text data in the render buffer allocated onto the VRAM 103. In the present embodiment, it is assumed that the text data contains the following twelve characters “ABCDEFGHIJKL”. An image is rendered in which a region of 256[px]×256 [px] is allocated for each character in sequence from the upper left of the buffer and three characters are provided in each row. The text image rendered in this way is as shown by 501 in FIG. 5. In the description of the present embodiment, it is assumed that the text image corresponding to the text data is rendered by using a region of 256 [px]×256 [px] for each character in sequence in a clockwise direction from the upper left of the allocated buffer. When there is no more render space in the row, the GPU 111 moves it to the left end of the next row and renders the next character.

In S404, in order to determine whether or not the display image rendered onto the VRAM 103 needs to be rotated when the display image is displayed on the display unit 107, the CPU 101 determines whether or not the orientation information indicates “vertically held state B”. As illustrated in FIGS. 3A to 3D, the “vertically held state B” has an upside-down relationship with the reference state. Accordingly, it is necessary to rotate the display image by 180 degrees such that the upper direction of the display image corresponds to the vertical upper direction in the real world. If it is determined that the orientation information indicates “vertically held state B”, the CPU 101 determines that rotation is necessary when displaying the rendered display image. If it is determined that the orientation information indicates “vertically held state B”, the CPU 101 advances the processing to S406. If it is determined that the orientation information indicates “vertically held state A”, the CPU 101 advances the processing to S405.

In S405, the GPU 111 transfers the display image to a display buffer for the display image allocated onto the VRAM 103 separately from the render buffer, without rotating the display image. The display buffer is a two-dimensional region provided so as to correspond to the representation of the display region of the display unit 107 in the reference state, and the upper left of the region corresponds to the upper left of the display unit 107 in the reference state, and the lower right of the region corresponds to the lower right of the display unit 107 in the reference state. Reference numeral 502 shown in FIG. 5 indicates a display image stored in the display buffer through the processing of this step, and as a result of the image being displayed at the corresponding position in the display unit 107, the display image is displayed in a display representation appropriate to the “vertically held state A” as indicated by 503.

If, on the other hand, it is determined in S404 that the orientation information indicates “vertically held state B”, in S406, the GPU 111 rotates the display image by 180 degrees, and transfers the display image to the display buffer. To be specific, the display image is stored in the display buffer in an upside-down state, as indicated by 507 in FIG. 5. Then, as a result of the display image being displayed at the corresponding position in the display unit 107, the display image is displayed in a display representation appropriate to the “vertically held state B” as indicated by 508.

In S407, under control of the CPU 101, the display control unit 108 reads the display image from the display buffer in the VRAM 103, and displays the display image on the display unit 107.

In S408, the CPU 101 determines whether or not a control signal that is an instruction to end the text display application has been received from the operation unit 109. If it is determined that a control signal that is an instruction to end the text display application has been received, the CPU 101 finishes the display control processing. If it is determined that a control signal that is an instruction to end the text display application has not been received, the CPU 101 advances the processing to S409.

In S409, the CPU 101 determines whether or not the orientation has been changed to a horizontally held state. To be specific, the CPU 101 refers to new orientation information obtained as a result of orientation detection performed by the orientation detection unit 106, and determines whether or not the orientation information indicates “horizontally held state A” or “horizontally held state B”. If it is determined that the orientation has been changed to a horizontally held state, the CPU 101 advances the processing to S410. If it is determined that the orientation has not been changed to a horizontally held state, the CPU 101 returns the processing to S403.

If, on the other hand, it is determined in S401 that the orientation information indicates “horizontally held state A” or “horizontally held state B”, in S410, the GPU 111 allocates a render buffer for the display image onto the VRAM 103. As the render buffer allocated at this time, because the tablet terminal 100 is in a horizontally held state, in the case where the display unit 107 in the reference state has a resolution of 768 [px]×1024 [px], a buffer having a width of 1024 [px] and a height of 768 [px] is allocated onto the VRAM 103.

In S411, the GPU 111 renders a text image corresponding to the text data in the render buffer in the same manner as in S403. The text image rendered in this step is as shown by 504 in FIG. 5. Because the buffer region is different from that allocated when the tablet terminal 100 is in a vertically held state, the number of rows and the number of columns of the alphabets are exchanged. As described above, the difference between the vertically held state and the horizontally held state is not only whether or not the tablet terminal 100 is simply rotated by 90 degrees, but also the layout of the content on the screen is changed.

In S412, in order to determine in which direction the display image rendered onto the VRAM 103 needs to be rotated by 90 degrees when displaying the display image on the display unit 107, the CPU 101 determines whether or not the orientation information indicates “horizontally held state B”. As illustrated in FIGS. 3A to 3D, the “horizontally held state A” is a state obtained by rotating the tablet terminal 100 in the reference state in a clockwise direction by 90 degrees, and thus the display image needs to be rotated in a counterclockwise direction by 90 degrees such that the upper direction of the display image corresponds to the vertical upper direction in the real world. Conversely, the “horizontally held state B” is a state obtained by rotating the tablet terminal 100 in the reference state in a counterclockwise by 90 degrees, and thus the display image needs to be rotated in a clockwise direction by 90 degrees such that the upper direction of the display image corresponds to the vertical upper direction in the real world. If it is determined that the orientation information indicates “horizontally held state A”, the CPU 101 advances the processing to S413. If it is determined that the orientation information indicates “horizontally held state B”, the CPU 101 advances the processing to S414.

In S413, the GPU 111 rotates the rendered image in a counterclockwise direction by 90 degrees, and transfers the display image to the display buffer. To be specific, the display image is stored in the display buffer, the display image being in a state in which it is rotated in a counterclockwise direction by 90 degrees, as indicated by 505 in FIG. 5. As a result of the display image being displayed at the corresponding position in the display unit 107, the display image is displayed in a display representation appropriate to the “horizontally held state A” as indicated by 506.

If, on the other hand, it is determined in S412 that the orientation information indicates “horizontally held state B”, in S414, the GPU 111 rotates the rendered image in a clockwise direction by 90 degrees, and transfers the display image to the display buffer. To be specific, the display image is stored in the display buffer, the display image being in a state in which it is rotated in a clockwise direction by 90 degrees, as indicated by 509 in FIG. 5. As a result of the display image being displayed at the corresponding position in the display unit 107, the display image is displayed in a display representation appropriate to the “horizontally held state B” as indicated by 510.

In S415, under control of the CPU 101, the display control unit 108 reads the display image from the display buffer in the VRAM 103, and displays the display image on the display unit 107.

In S416, the CPU 101 determines whether or not a control signal that is an instruction to end the text display application has been received, as in S408. If it is determined that a control signal that is an instruction to end the text display application has been received, the CPU 101 ends the display control processing. If it is determined that a control signal that is an instruction to end the text display application has not been received, the CPU 101 advances the processing to S417.

In S417, the CPU 101 determines whether or not the orientation has been changed to a vertically held state, as in S409. If it is determined that the orientation has been changed to a vertically held state, the CPU 101 advances the processing to S402. If it is determined that the orientation has not been changed to a vertically held state, the CPU 101 returns the processing to S411.

In the present embodiment, the display control processing has been described taking a text display application as an example, but the application range of the present invention is not limited thereto. For example, similar processing is applicable as long as an application that performs the following steps to render and display a display image is used (for example, a web browser that renders an HTML file, or the like):

1. performing orientation detection and changing the resolution of the render buffer depending on the horizontally held state or the vertically held state;

2. rotating the image data rendered in the render buffer according to the detected orientation; and

3. transferring the display image from the render buffer to the display buffer (scaling processing may be performed at this time), and then displaying the display image.

Image Presentation in Image Presentation System

Next is a description of overall operations for transmitting a display image displayed on the display unit 107 of the tablet terminal 100 to the liquid crystal projector 200 so as to project the display image, which are performed in the image presentation system of the present embodiment. The overall operations will be described on the assumption that a communication connection has already been established between the tablet terminal 100 and the liquid crystal projector 200 via the communication unit 110 and the communication unit 209.

It is assumed that a screen transmission application that transmits and projects a captured image on the display screen has already been installed on the tablet terminal 100 of the present embodiment. During execution of the screen transmission application, the CPU 101 acquires (captures) a display image stored in the display buffer at a predetermined timing, and stores the captured image in the RAM 102. The images obtained by capturing are images indicated by 502, 505, 507 and 509 in FIG. 5. Hereinafter, these images will be referred to as “captured images”.

When a captured image is stored in the RAM 102, the CPU 101 applies, to the captured image, processing to change the format to a transmission format such as, for example, a JPEG encoding format. Then, the CPU 101 transmits the processed captured image to the communication unit 110, and transmits the image to the liquid crystal projector 200 together with rotation information indicating how the image is rotated and projected to the liquid crystal projector 200.

As described above, the display buffer is a two-dimensional region provided so as to correspond to the representation of the display region of the display unit 107 of the tablet terminal 100 in the reference state. That is, the captured image is simply intended to be appropriately displayed on the display unit 107 taking the orientation of the tablet terminal 100 into consideration. Accordingly, if the captured image is directly projected to the liquid crystal projector 200, there is a possibility that the captured image may not be projected in the correct up-down relationship. The rotation information is information containing a rotation instruction to project such a captured image to the liquid crystal projector 200 in the correct up-down relationship. To be specific, the rotation information contains a rotation instruction to not rotate the image in the case of “vertically held state A”, a rotation instruction to rotate the image by 180 degrees in the case of “vertically held state B”, a rotation instruction to rotate the image in a clockwise direction by 90 degrees in the case of “horizontally held state A”, or a rotation instruction to rotate the image in a counterclockwise direction by 90 degrees in the case of “horizontally held state B”.

In the liquid crystal projector 200, upon receiving the captured image and the rotation information transmitted as described above, the CPU 201 stores the image and the rotation information in the RAM 202. Then, the CPU 201 causes the decoder 205 to decode the received captured image, causes the image processing unit 210 to apply image processing necessary to project the image, such as rotation processing according to the rotation information and scaling processing, and thereafter causes the VRAM 204 to generate a projection image. After the projection image is loaded onto the VRAM 204 in this way, under control of the CPU 201, the projection control unit 207 causes the projection unit 206 to project the image so as to present the image onto the projection surface.

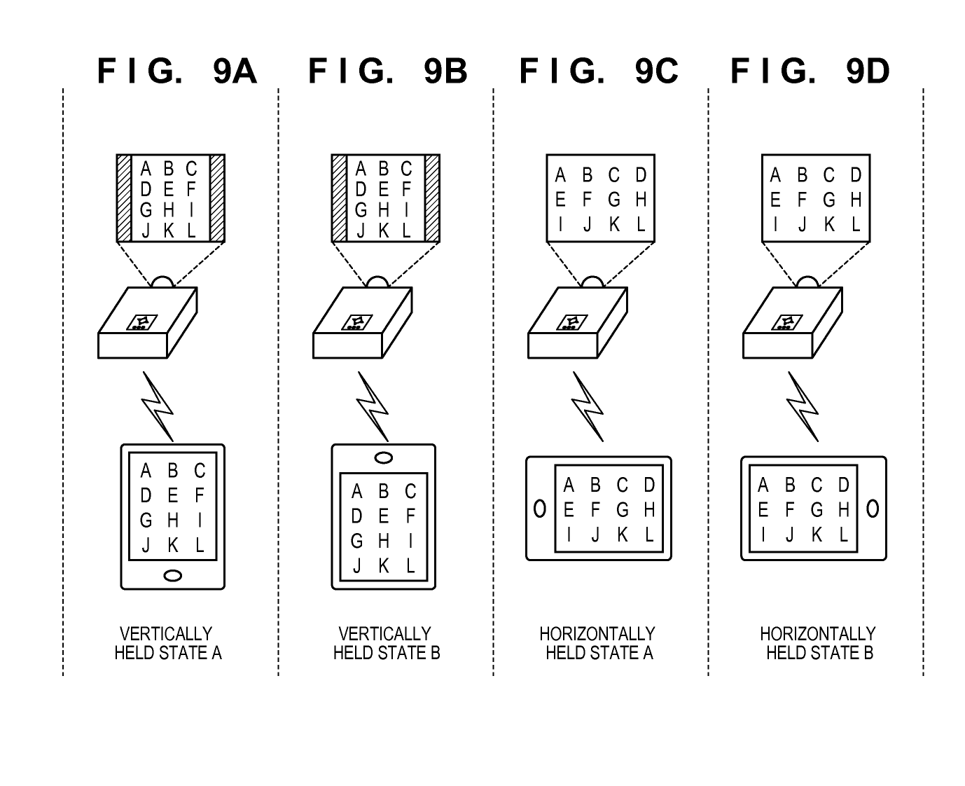

In the manner described above, each of the images 502, 505, 507 and 509 shown in FIG. 5 is rotated as appropriate and presented onto the projection surface as shown in FIGS. 9A to 9D.

However, as described above, the display image generated when the tablet terminal 100 is in a vertically held state and the display image generated when the tablet terminal 100 is in a horizontally held state are different in terms of the resolution and the positions of the displayed objects. For this reason, if the orientation of the tablet terminal 100 is changed during projection of a display image, such as in the case where, for example, FIG. 9A and FIG. 9C are alternately displayed, it is difficult for the observer to view the presented images.

Screen Transmission Processing

Hereinafter, screen transmission processing that avoids such undesirable image presentation, executed by the tablet terminal 100 of the present embodiment will be described specifically with reference to the flowcharts shown in FIGS. 6A and 6B. The processing corresponding to the flowchart can be implemented by the CPU 101 reading the corresponding processing program recorded in, for example, the HDD 105, loading the program into the RAM 102, and executing the program. This screen transmission processing will be described on the assumption that the screen transmission processing is started when, for example, a screen transmission application is executed in the tablet terminal 100. Also, in the screen transmission processing, steps that perform the same processing as in the display control processing described above are given the same reference numerals, and descriptions thereof are omitted.

In S601, the CPU 101 controls the communication unit 110 so as to try to establish a communication connection with the liquid crystal projector 200. Then, the CPU 101 determines whether or not a communication connection has been established. To be specific, the CPU 101 determines whether or not a notification indicating receipt of a connection request has been received from the liquid crystal projector 200 that has received a request to establish a communication connection, by determining whether or not the corresponding event has been notified from the communication unit 110. If it is determined that a communication connection has been established, the CPU 101 advances the processing to S602. If it is determined that a communication connection has not been established, in this step, the CPU 101 waits for establishment of a communication connection.

In S602, the CPU 101 determines whether or not the application (application of interest) causing the display unit 107 to display the display image is an application as described above that changes the display representation according to the orientation of the tablet terminal 100. As used herein, the application of interest refers to an application that generates a display image, which is content to be displayed, transmits the display image to the liquid crystal projector 200 with the use of a screen transmission application, and presents the display image. The application of interest is an application that requires a GUI display on the display unit 107 during execution thereof such as a photograph viewing application, a web browser application or a text display application. If it is determined that the application of interest is an application that changes the display representation according to the orientation, the CPU 101 advances the processing to S603. If it is determined that the application of interest is not an application that changes the display representation according to the orientation, the CPU 101 executes the above-described normal screen transmission processing that performs a screen presentation operation.

In S603, the CPU 101 acquires information (screen information) regarding the image presented by the liquid crystal projector 200. To be specific, the CPU 101 transmits a screen information transmission request to the liquid crystal projector 200 via the communication unit 110, and receives the information as a response to the request. The screen information is information indicating the projection resolution in the liquid crystal projector 200 used when projecting the input image signal, and may be information indicating, for example, the width and height of the image formed on the liquid crystal panel of the projection unit 206, which are expressed in the number of pixels. The configuration of the screen information is not limited thereto, and the screen information may be information indicating, for example, the aspect ratio of the image formed on the liquid crystal panel.

In S604, the CPU 101 refers to the acquired screen information, and determines whether the image presented by the liquid crystal projector 200 is a portrait image (in which the longitudinal direction corresponds to the height direction) or a landscape image (in which the longitudinal direction corresponds to the width direction). If it is determined that the image presented by the liquid crystal projector 200 is a portrait image, the CPU 101 advances the processing to S402. If it is determined that the image presented by the liquid crystal projector 200 is a landscape image, the CPU 101 advances the processing to S410.

After the processing from steps S402 to S407 have been performed, in 5605, the CPU 101 captures a display image stored in the display buffer in the VRAM 103, and stores the acquired display image in the RAM 102 as a captured image. Also, the CPU 101 acquires information indicating whether or not the display image stored in the display buffer has been rotated by 180 degrees. If the information indicates that the display image has been rotated by 180 degrees, the CPU 101 generates rotation information containing an instruction to rotate the image by 180 degrees. Then, the CPU 101 transmits the captured image obtained by application of encoding processing and the rotation information to the communication unit 110 so as to transmit them to the liquid crystal projector 200.

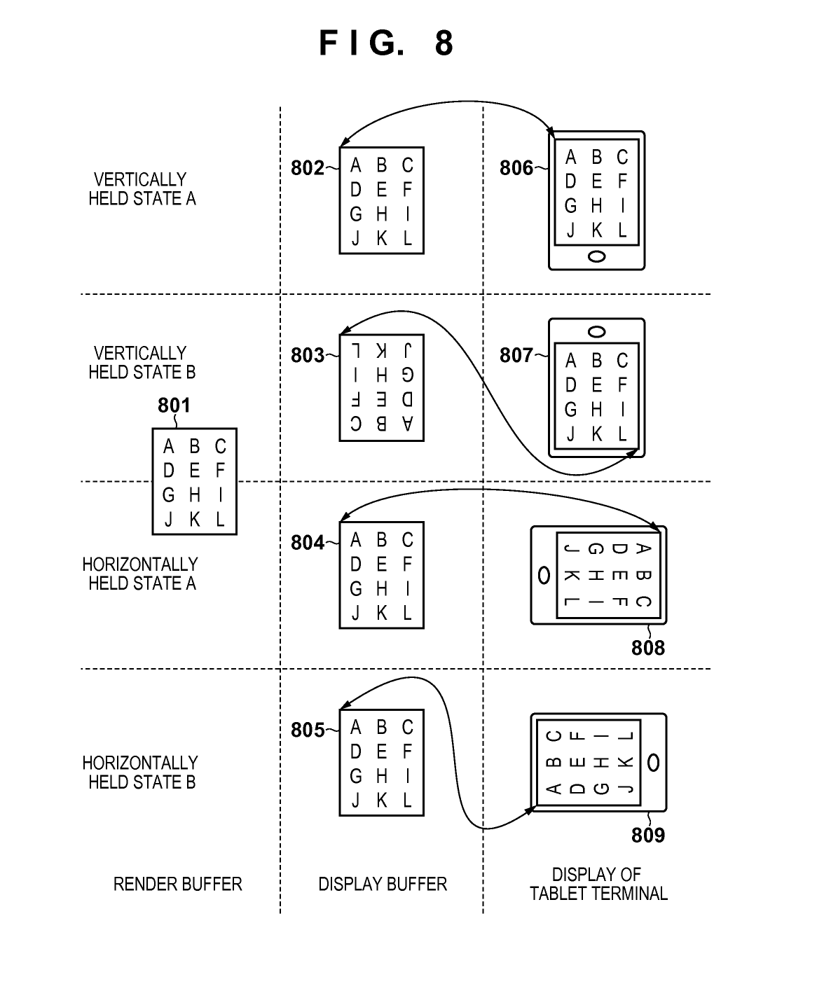

In this way, in the screen transmission processing of the present embodiment, if the image presented by the liquid crystal projector 200 is a portrait image, a portrait display image for a vertically held state as indicated by 801 in FIG. 8 is rendered in the render buffer in the VRAM 103 irrespective of the orientation of the tablet terminal 100. That is, in the screen transmission application of the present embodiment, during establishment of a communication connection between the tablet terminal 100 and the liquid crystal projector 200, the display image displayed on the display unit 107 of the tablet terminal 100 is fixed in portrait orientation. In other words, during establishment of the communication connection, the resolution of the render buffer allocated onto the VRAM 103 is fixed to that for portrait orientation.

Also, in the present embodiment, if the tablet terminal 100 is in the “vertically held state B”, the display image stored in the display buffer is an image that has been turned upside down. In FIG. 8, in the horizontally held states, loading of the display image onto the display buffer is controlled so as to not change the resolution between the image in the “vertically held state A” and the captured image. However, in the “vertically held state B”, because a display image having the same resolution as that of the image in the “vertically held state A” can be obtained, the display image is allowed to be rotated by 180 degrees when loading the display image onto the display buffer. That is, in this step, if the tablet terminal 100 is in the “vertically held state B”, the display image is allowed to be rotated by 180 degrees so that the display image is displayed on the display unit 107 by giving a higher priority to the visibility of the tablet terminal 100 by the user.

In S606, the CPU 101 determines whether or not a control signal containing an instruction to end the screen transmission application has been received. If it is determined that a control signal containing an instruction to end the screen transmission application has been received, the CPU 101 ends the screen transmission processing. If it is determined that a control signal containing an instruction to end the screen transmission application has not been received, the CPU 101 returns the processing to S403.

If, on the other hand, it is determined in S604 that the image presented by the liquid crystal projector 200 is a landscape image, after the processing from steps S410 to S415 have been performed, in 5607, the CPU 101 captures a display image stored in the display buffer, and stores the captured display image in the RAM 102. Also, the CPU 101 acquires information indicating whether or not the display image stored in the display buffer has been rotated in a clockwise direction by 90 degrees. If it is determined that the display image has been rotated in a clockwise direction by 90 degrees, the CPU 101 generates rotation information containing an instruction to rotate the display image in a counterclockwise direction by 90 degrees. If it is determined that the display image has not been rotated in a clockwise direction by 90 degrees, the CPU 101 generates rotation information containing an instruction to rotate the display image in a clockwise direction by 90 degrees, then, the CPU 101 transmits the captured image obtained by application of encoding processing and the rotation information to the communication unit 110 so as to transmit them to the liquid crystal projector 200.

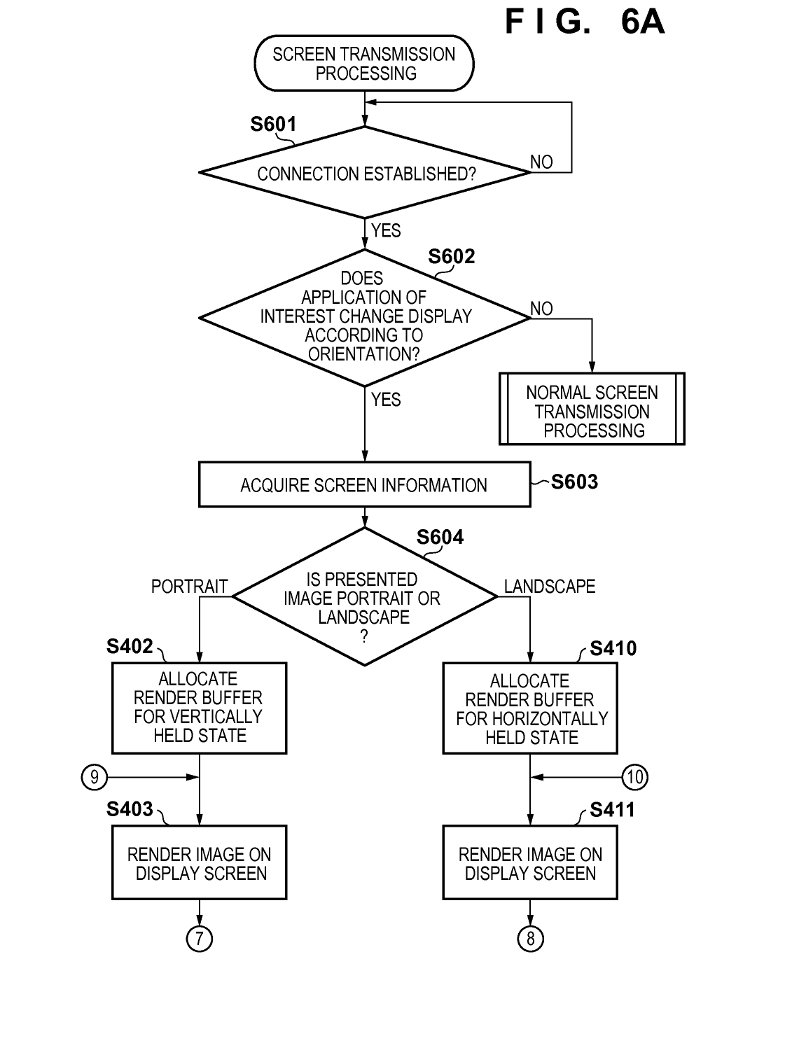

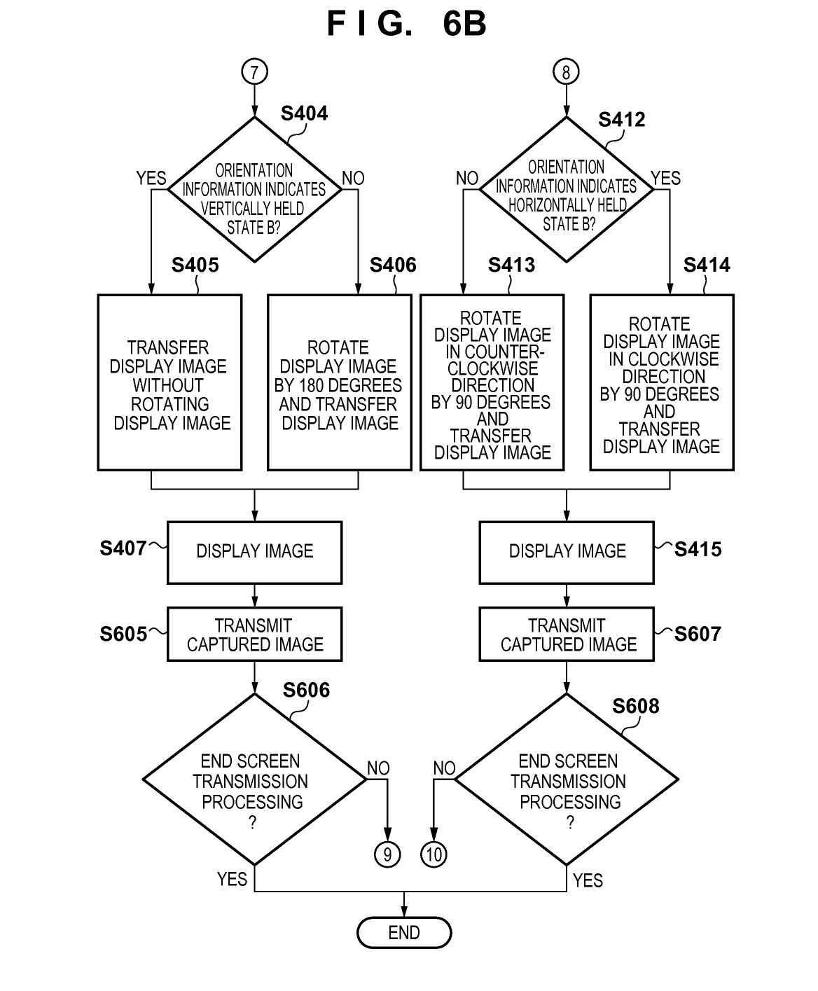

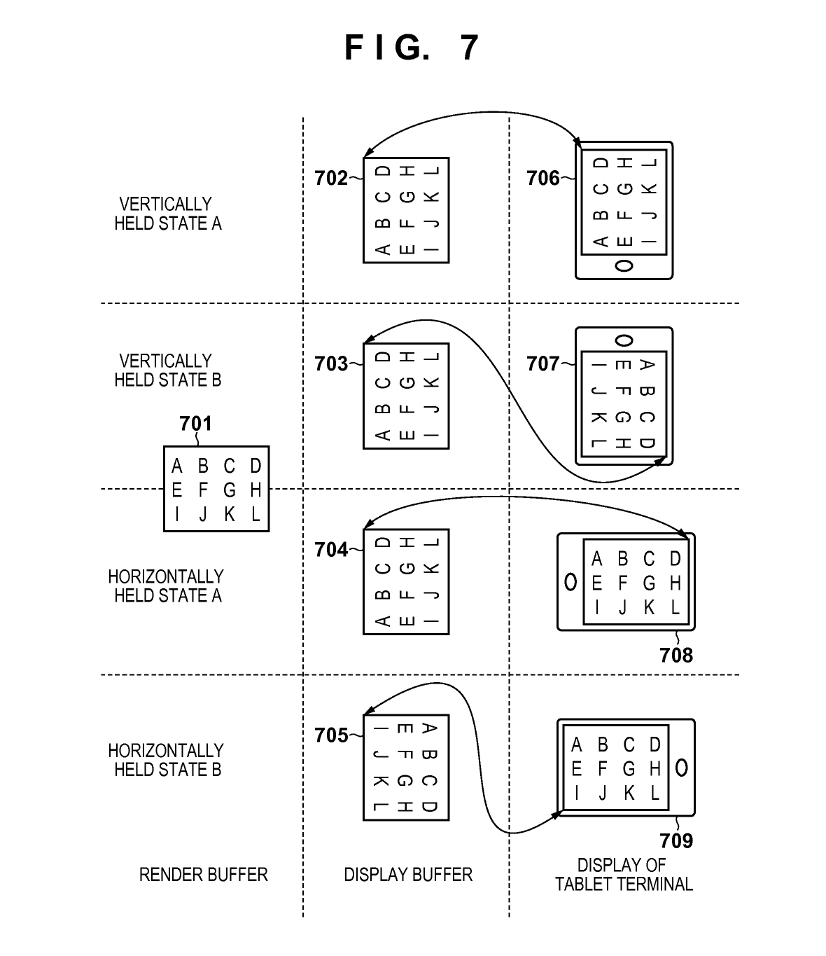

In this way, in the screen transmission processing of the present embodiment, if the image presented by the liquid crystal projector 200 is a landscape image, a landscape display image for a horizontally held state as indicated by 701 in FIG. 7 is rendered in the render buffer in the VRAM 103 irrespective of the orientation of the tablet terminal 100. That is, in the screen transmission application of the present embodiment, during establishment of a communication connection between the tablet terminal 100 and the liquid crystal projector 200, the display image displayed on the display unit 107 of the tablet terminal 100 is fixed in landscape orientation. In other words, during establishment of the communication connection, the resolution of the render buffer allocated onto the VRAM 103 is fixed to that for landscape orientation.

Also, in the present embodiment, if the tablet terminal 100 is in the “horizontally held state B”, the display image stored in the display buffer is an image that has been rotated in a clockwise direction by 90 degrees. Otherwise, the display image stored in the display buffer is an image that has been rotated in a counterclockwise direction by 90 degrees. In FIG. 7, in the vertically held states, loading of the display image onto the display buffer is controlled so as to not change the resolution between the image in the “horizontally held state A” and the captured image. However, in the “horizontally held state B”, because a display image having the same resolution as that of the image in the “horizontally held state A” can be obtained, the display image is allowed to be rotated in a clockwise direction by 90 degrees when loading the display image onto the display buffer. That is, in this step, if the tablet terminal 100 is in the “horizontally held state B”, the display image is allowed to be rotated in a direction opposite to that in the case of “horizontally held state A” so that the display image is displayed on the display unit 107 by giving a higher priority to the visibility of the tablet terminal 100 by the user.

In S608, the CPU 101 determines whether or not a control signal containing an instruction to end the screen transmission application has been received. If it is determined that a control signal containing an instruction to end the screen transmission application has been received, the CPU 101 ends the screen transmission processing. If it is determined that a control signal containing an instruction to end the screen transmission application has not been received, the CPU 101 returns the processing to S411.

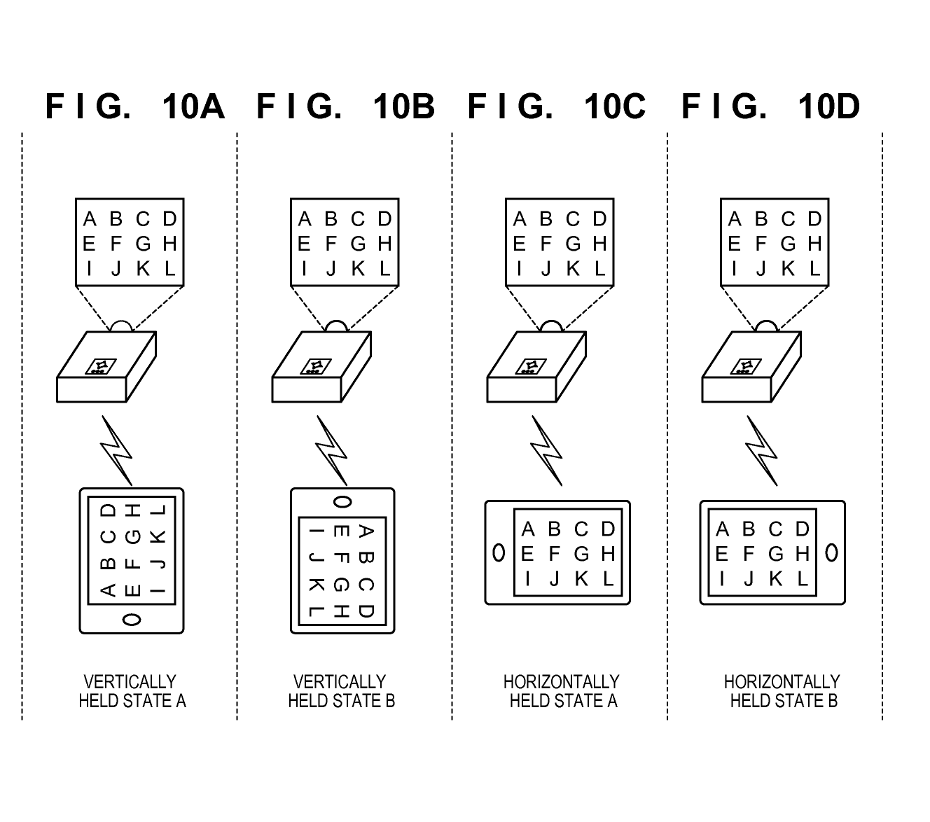

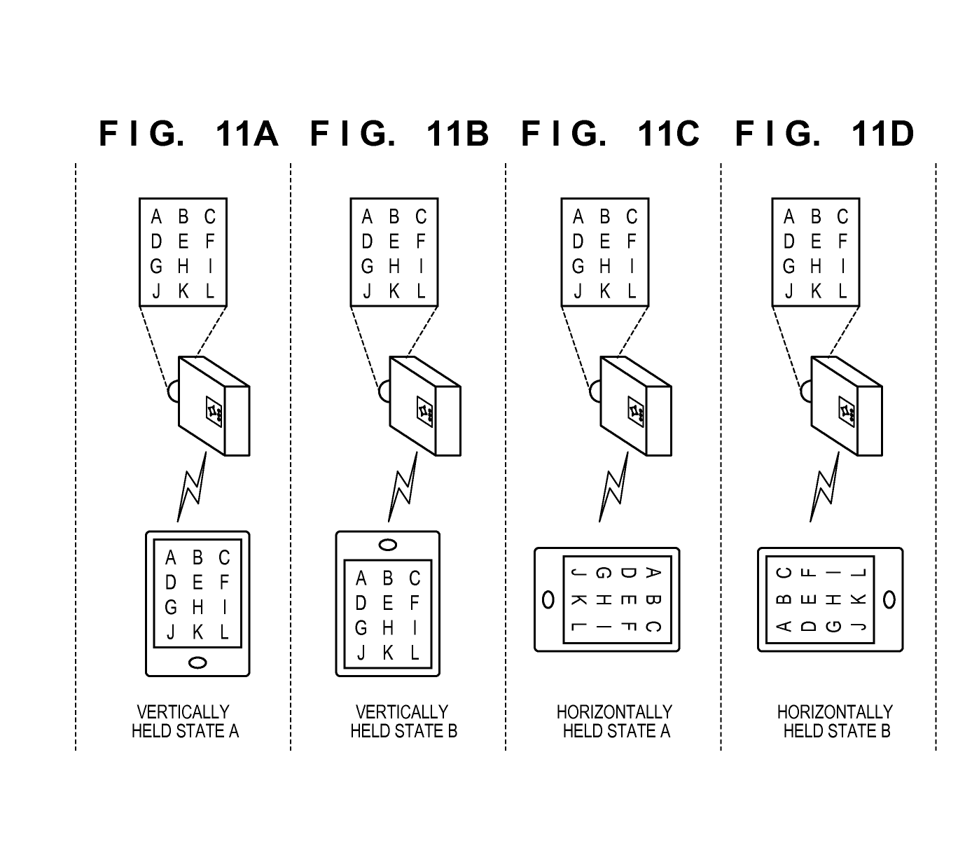

By doing so, in the image presentation system of the present embodiment, images having the same resolution can be presented onto the liquid crystal projector 200 irrespective of changes in the orientation of the tablet terminal 100. To be specific, FIGS. 10A to 10D show the case where a landscape image is presented by the liquid crystal projector 200. FIGS. 11A to 11D show the case where a portrait image is presented by the liquid crystal projector 200. Accordingly, the observer can view the presented images without having any difficulty in viewing the images due to changes in resolution. Also, the user of the tablet terminal 100 can present images without having concern for the orientation of the tablet terminal 100 he/she is holding.

In the image transmission processing of the present embodiment, a higher priority is given to the visibility of the tablet terminal 100 by the user, and thus when loading a display image onto the display buffer, rotation is allowed to some degree, but the embodiment of the present invention is not limited thereto. That is, the display image loaded onto the display buffer may constantly have the same up-down direction irrespective of the orientation of the tablet terminal 100.

Also, in the present embodiment, the screen information acquired from the liquid crystal projector 200 is referred to when determining the resolution for the render buffer allocated onto the VRAM 103, but the embodiment of the present invention is not limited thereto. The resolution may be determined by, for example, the user selecting whether he/she uses the tablet terminal 100 in a vertically held state or in a horizontally held state. Alternatively, the resolution may be determined by notifying the user of the fact that a change in orientation that requires a change in resolution has been detected, and receiving a response to an inquiry as to whether or not the aspect ratio of the image to be transmitted needs to be changed. Alternatively, the display representation during execution of the screen transmission application may simply be continued.

Also, in the present embodiment, the captured image is captured from the display buffer, but the present embodiment is not limited thereto, and the captured image may be captured from the render buffer. In this case, it is possible to omit the transmission of the rotation information.

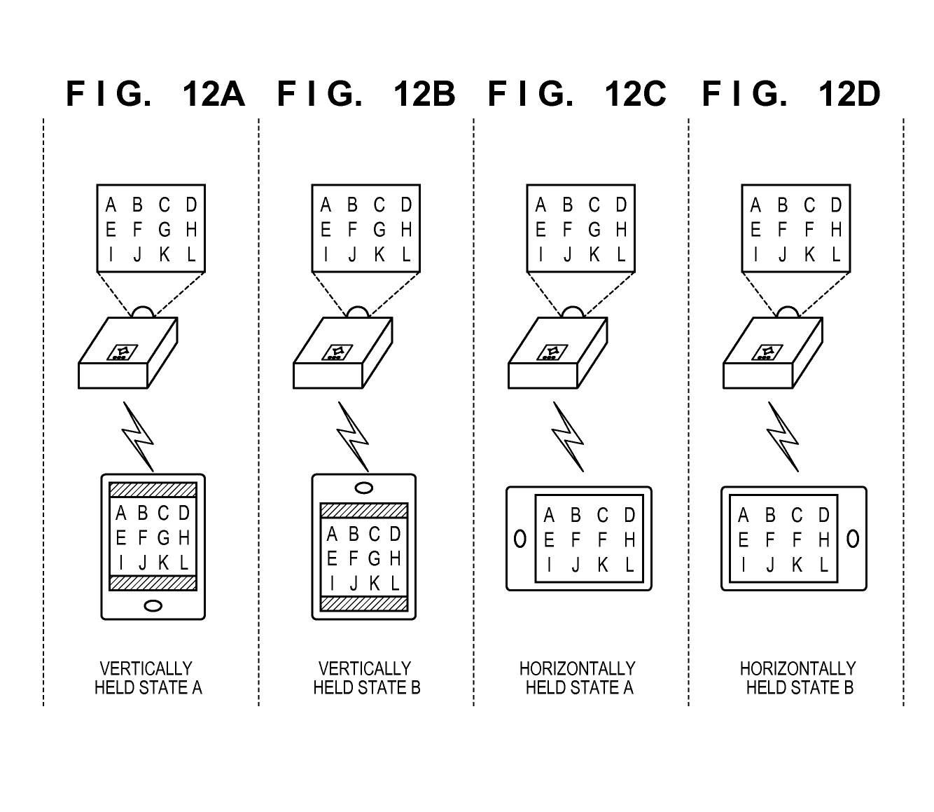

Also, the rotation processing when loading the display image onto the display buffer may be performed by taking only the visibility on the liquid crystal projector 200 into consideration so as to have a configuration that gives a higher priority to both the visibility of the image presented by the liquid crystal projector 200 and the visibility of the display image on the display unit 107. To be specific, as shown in FIGS. 12A to 12D, processing may be performed such that landscape (or portrait) display images are always displayed on the display unit 107, and landscape (or portrait) images are always transmitted to the liquid crystal projector 200 irrespective of the orientation of the tablet terminal 100.

Also, in the present embodiment, a buffer region is allocated according to the orientation, and an image is rendered so as to fit the buffer region. However, the present invention is not limited to this configuration. For example, a configuration is also possible in which portrait layout information and landscape layout information are stored in advance, the layout information is referred to according to the orientation, and a display screen is rendered in the buffer.

As described thus far, the image transmitting apparatus according to the present embodiment can appropriately present, to the outside, a display image displayed on the apparatus that performs display control according to the orientation of the apparatus.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-255369, filed Dec. 10, 2013, which is hereby incorporated by reference herein in its entirety.

What is claimed is:

1. An image transmitting apparatus that renders a display image that is displayed on a display unit according to an orientation of the image transmitting apparatus, the apparatus comprising:
a detecting unit configured to detect the orientation of the image transmitting apparatus;
a rendering unit configured to render the display image having a resolution determined according to the orientation of the image transmitting apparatus detected by the detecting unit; and
a communication unit configured to establish a communication connection with an image presentation apparatus, and capture and transmit the display image rendered by the rendering unit at a predetermined timing,
wherein the rendering unit is configured to, if the communication connection with the image presentation apparatus performed by the communication unit is established, fix the resolution and render the display image irrespective of the orientation of the image transmitting apparatus.

2. The image transmitting apparatus according to claim 1,
wherein the rendering unit is configured to:
differentiate resolution of a two-dimensional render region allocated to render the display image according to the orientation of the image transmitting apparatus, and
if the communication connection with the image presentation apparatus is established, leave the render region unchanged irrespective of the orientation of the image transmitting apparatus.

3. The image transmitting apparatus according to claim 1,
wherein the rendering unit is configured to, if the communication connection with the image presentation apparatus is established, determine the resolution of the display image according to an aspect ratio used to perform image presentation on the image presentation apparatus.

4. The image transmitting apparatus according to claim 1,
wherein the rendering unit is configured to, if the communication connection with the image presentation apparatus is established, determine the resolution of the display image according to content to be displayed that constitutes the display image.

5. The image transmitting apparatus according to claim 1,
wherein the rendering unit is configured to, if the communication connection with the image presentation apparatus is established, fix the resolution of the display image to a resolution if the communication connection was established.

6. The image transmitting apparatus according to claim 1, further comprising a notification unit configured to, if the communication connection with the image presentation apparatus is established, notify that a change has been detected in the orientation by the detecting unit, the change in the orientation being a change with which the resolution of the display image of the image transmitting apparatus is changed,
wherein the rendering unit is configured to, if an instruction to change the resolution of the display image is received in response to the notification by the notification unit, render the display image with the resolution determined according to the orientation of the image transmitting apparatus.

7. An image presentation system in which an image presentation apparatus presents an image transmitted from an image transmitting apparatus,
the image transmitting apparatus comprising:
a detecting unit configured to detect an orientation of the image transmitting apparatus;
a rendering unit configured to render a display image that is displayed on a display unit and has a resolution determined according to the orientation of the image transmitting apparatus detected by the detecting unit; and
a communication unit configured to establish a communication connection with an image presentation apparatus, and capture and transmit the display image rendered by the rendering unit at a predetermined timing,
the image presentation apparatus comprising:
a receiving unit configured to receive the display image transmitted by the communication unit; and
a presentation unit configured to present the display image received by the receiving unit,
wherein the rendering unit is configured to, if a communication connection with the image presentation apparatus is established by the communication unit, fix the resolution and render the display image irrespective of the orientation of the image transmitting apparatus.

8. A method for controlling an image transmitting apparatus that renders a display image displayed on a display unit according to an orientation of the image transmitting apparatus, the method comprising:
detecting the orientation of the image transmitting apparatus;
rendering the display image having a resolution determined according to the detected orientation of the image transmitting apparatus; and
establishing a communication connection with an image presentation apparatus, and capturing and transmitting the rendered display image at a predetermined timing,
wherein if the communication connection with the image presentation apparatus is established, the display image is rendered with the resolution being fixed irrespective of the orientation of the image transmitting apparatus.
